(19) United States
(12) Patent Application Publication
(10) Pub. No.: US 2008/0227613 A1
(43) Pub. Date: Sep. 18, 2008

(54) Method For Flat Bed Die Cutting of Packaging Blanks With the Female Cutting Plate Having a Channel

(76) Inventors: John McKellar, Glasgow (GB); Edmond Maccarthy, Kent (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/091,778

(22) PCT Filed: Oct. 18, 2006
(86) PCT No.: PCT/GB06/03851

§ 371 Date: Apr. 28, 2008

(30) Foreign Application Priority Data
Oct. 26, 2005 (GB) 0521806.0
Mar. 30, 2006 (GB) 0606500.7
Sep. 22, 2006 (GB) 0618723.1

(51) Int. Cl. B31F 5/02; B31B 1/14

(52) U.S. Cl. 493/354; 493/362

(57) ABSTRACT

Using Zero Make Ready Bed Die Cutting, the top surface of the Cutting Plate/Platen/counter of a Flat Bed Die Cutting Machine is etched or engraved by laser or other method, to create a “female” channel. The channel should be sufficiently deep and wide, to accommodate the male cutting blades of the Cutting Forme being used. Cutting blade contact with the base of the channel, whilst not desirable, may occur due to reasons of machine age and/or wear or Operator ability or preference. The fundamentals of Zero Make-Ready remain unaffected. The Cutting Plate/Platen can be of a single or multi layered composition and should be affixed and registered at the same time that the cutting Forme is loaded and located. Using centre lines, locating pins, or any other method of registering the two, the female channel must register with and accommodate, the male cutting blades to affect a clean cut of the required design of die cut blank or shape.

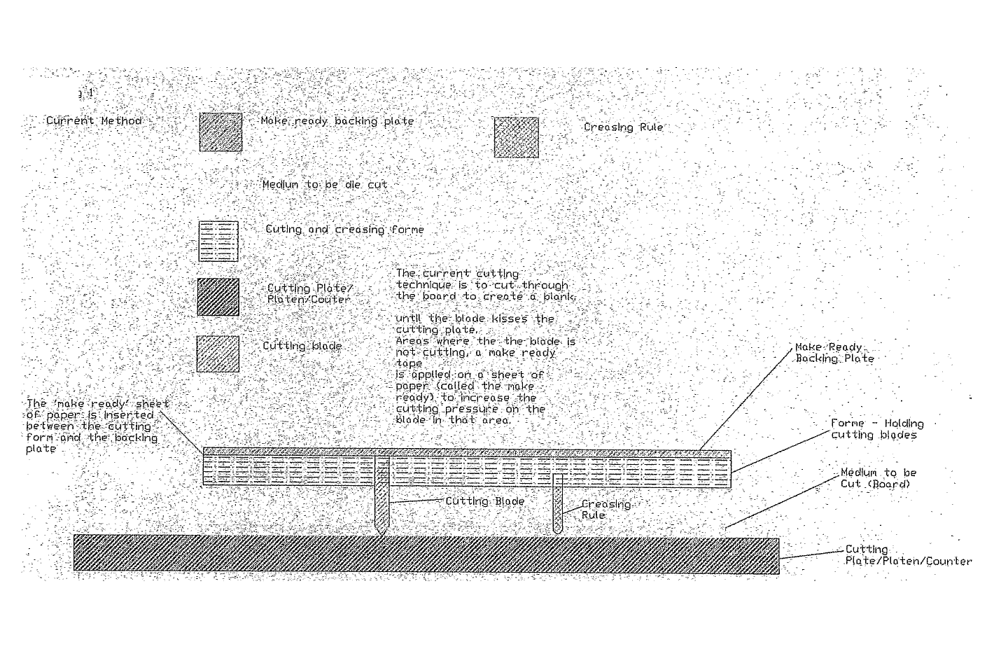

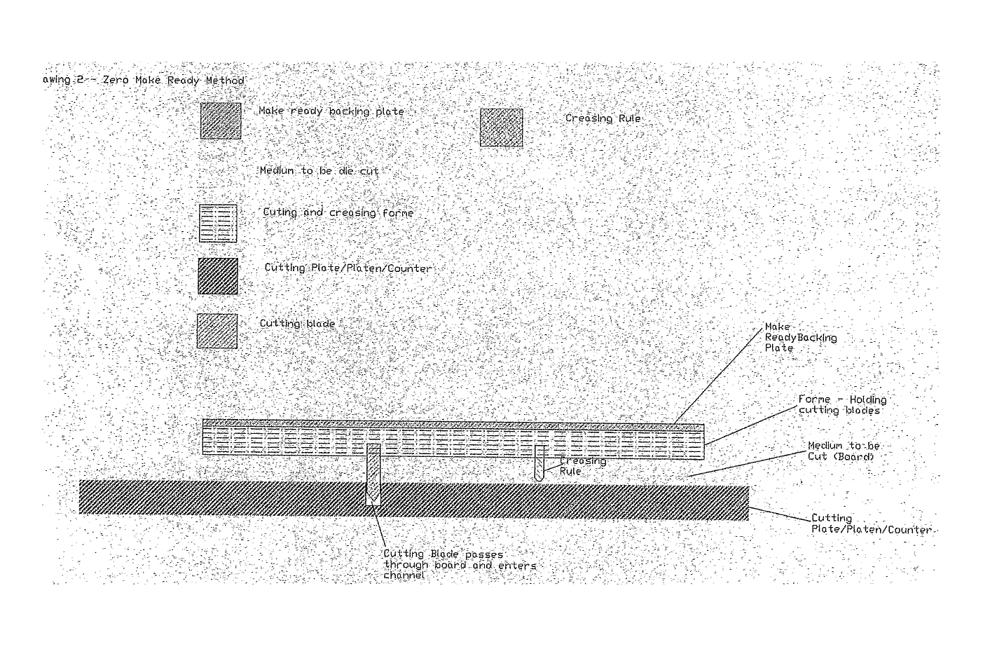

### BACKGROUND

The current method of flat-bed die cutting in the packaging and other sectors, relies on a cutting blade protruding from a Forme (Drawing 1) to cut through cardboard or other material and make contact with a cutting surface or Platen under sufficient pressure to effect a clean cut (Drawing 1) in order to sever the waste area from the saleable die-cut ‘blank’. Each die-cutting Forme has cutting blades and creasing rules arranged so as to stamp out a blank to a required design. The blank when glued or similarly joined or formed, makes a corrugated or cardboard box or tray. This flat bed die cutting method is typical of many other industries where flat bed die cutting is employed.

Flat bed die cutting relies on a cutting forme, containing cutting blade to cut/stamp out a blank/shape through a process where the blade passes through the material/board and makes contact with a cutting plate/platen to affect a cut and therefore a separation of saleable area and waste area. Creasing rule makes surface contact to create a score allowing the material to fold accurately into a pre-determined structure.

Long set up times can and frequently do occur due to the uneven wear of the platen and cutting rule created by the contact method of die cutting. There is also the separate issue of vertical inaccuracy of the cutting blades, which, if not fixed at a consistent 90 degrees over all of the cutting area of the forme, will compound a lack of uniformity.

This current and usual method of achieving a uniformed cut is to “pack” the blades that are not cutting by fixing non-compressible tape to the plate at the back of the Forme. Too little tape has no effect and too much means removal of some or the taping of the blade that was previously cutting. It is not uncommon for the machine Crew to refer to this “Make-Ready” stage as “chasing their tail”. This stage can also be referred to as Patch Up.

Obviously this means lost Production time and because of the trial and error method of “fixing” the problem. This inflicts more damage/wear on the already inaccurate Forme or Platen surface. Occasionally the machine Crew will opt to increase pressure between the forme and platen to force the blades which are not cutting, to cut without the need for tape. This crude method will shorten the lifespan of the tooling and in some cases the blades can damaged and may need to be replaced. This is extreme, but by no means uncommon.

### STATEMENT OF INVENTION

To overcome the issue of extended set up times resulting in lost production time, the Zero Make Ready method proposes, that through the negation of cutting blade contact with a platen surface, by means of an etched or engraved channel in a female Cutting Plate, set up time is reduced considerably or negated as is wear on the cutting blades and also the Platen/Cutting Plate. The trial and error Make Ready method of machine setting that creates partially or inaccurately cut product is also removed, thereby reducing waste product that is a necessary by product of trial and error setting. Employing this new Zero Make Ready method does not guarantee that there will be absolutely zero contact of the blade and the base of the channel. This may be due to Operator skill level, Operator choice, or indeed lack of machine accuracy for any reason including age and/or wear. If there is minimal contact, Zero Make Ready is still achieved.

### DESCRIPTION

The new Zero Make Ready Flat Bed Die-Cutting method offers a solution by negating the need for the cutting blade to contact any surface at any time other than as described previously. The blade passes through the corrugated fibreboard or solid cardboard (or other material) and enters a channel in the Platen or Cutting Plate (Drawing 2) before returning to the start point when the machine cycle begins again.

The top surface of the Platen or Cutting Plate (Female/Counter), which can be single or multi-layered and which is registered with the Cutting Forme (Male) during machine setting, will be etched or engraved, by laser or other method, to create a corresponding and opposite channel to accommodate the entering blade or blades. The channel needs only to be sufficiently deep and wide to accommodate the entering and retracting blade. The channel will be shaped to best accommodate the profile of the cutting blade. Notching, or attaching of waste, to assist transfer through an automatic or semi-automatic machine, will still be done in the preferred manner of the individual.

The machine can now be set with the cutting blades of the Forme passing through and beyond the material cutting at every point when entering the channel in the Cutting Plate (Female/Counter) there is therefore no need for “make ready” taping to level vertical inaccuracy of the blades in the forme, or indeed an uneven cutting surface.

Setting times are therefore limited to the loading of the Tooling Set, male and female, onto the machine. Running adjustments are absolutely minimised or perhaps even eliminated. Waste product is also reduced, as trial and error Make Ready adjustments are no longer required.

1-4. (canceled)

5. A method of affecting clean cutting of a packaging blank from waste areas of material during flat bed die cutting, using a cutting rule or blade and Platen or Female Cutting Plate/Counter that includes a cutting surface, which involves the cutting rule or blade passing all the way through the corrugated, carton board, or other sheet material and entering a corresponding channel to and periodically accommodating, the cutting rule or blade; separation of the saleable blank or required area from the waste areas, takes place at a second stage; the waste area is notched in place during the cutting process to facilitate transfer to the separation stage, wherein a make ready is not required even if the cutting rule or blade contacts the base of the channel because the material would already be cut before this occurs.

6. A method according to claim 5 wherein the cutting rule or blade enters an etched or engraved channel under controlled pressure to affect a cut, and then withdraws and returns to the start point.

7. A tooling set used in the method of cutting a packaging blank from waste areas of material according to claim 5 including a Forme (Male) containing the cutting blade and the Platen or Cutting Plate (Female) that uniquely corresponds to that Forme and has within it Zero Make Ready Flat Bed Die-Cutting (ZMR) Channel, wherein the tooling set should be loaded in a Male/Female relationship in the Cutting Section on a Flat Bed Die Cutting machine.

8. A tooling set used in the method of cutting a packaging blank from waste areas of material according to claim 5 including a Forme (Male) containing the cutting blade and the Platen or Cutting Plate (Female) that uniquely corresponds to that Forme and has within it Zero Make Ready Flat Bed Die-Cutting (ZMR) Channel, wherein the tooling set should be loaded in a Male/Female relationship in the Cutting Section on a Flat Bed Die Cutting machine.

9. A tooling set used in the method of cutting a packaging blank from waste areas of material according to claim 6 including a Forme (Male) containing the cutting blade and the Platen or Cutting Plate (Female) that uniquely corresponds to that Forme and has within it Zero Make Ready Flat Bed Die-Cutting (ZMR) Channel, wherein the tooling set should be loaded in a Male/Female relationship in the Cutting Section on a Flat Bed Die Cutting machine.

10. A tooling set used in the method of cutting a packaging blank from waste areas of material according to claim 6 including a Forme (Male) containing the cutting blade and the Platen or Cutting Plate (Female) that uniquely corresponds to that Forme and has within it Zero Make Ready Flat Bed Die-Cutting (ZMR) Channel, wherein the tooling set should be loaded in a Male/Female relationship in the Cutting Section on a Flat Bed Die Cutting machine.
